(19) United States
(12) Patent Application Publication
(10) Pub. No.: US 2026/0352342 A1
(43) Pub. Date: Nov. 5, 2026

(54) OPTICAL TRANSMISSION SYSTEM AND SIGNAL DISTORTION COMPENSATION METHOD

(71) Applicant: NTT, Inc., Tokyo (JP)

(72) Inventors: Fukutaro HAMAOKA, Musashino-shi (JP); Masanori NAKAMURA, Musashino-shi (JP); Takeo SASAI, Musashino-shi (JP); Takayuki KOBAYASHI, Musashino-shi (JP)

(73) Assignee: NTT, Inc., Tokyo (JP)

(21) Appl. No.: 19/106,459

(22) PCT Filed: Aug. 30, 2022
(86) PCT No.: PCT/JP2022/032540

§ 371 Date: Feb. 25, 2025

(51) Int. Cl. H04B 10/58; H04B 10/61

(52) U.S. Cl. CPC H04B 10/58; H04B 10/61

(57) ABSTRACT

An optical transmission system includes an optical transmitter and an optical receiver. The optical transmitter includes an operation mode control unit that sets one of a first operation mode for generating a signal of a low symbol rate and a second operation mode for generating a signal of a high symbol rate, and a transmission signal generation unit that generates a transmission signal according to the operation mode. The optical receiver includes an optical coherent receiver, a digital signal processing unit, and a reception data demodulation unit. The optical transmitter or the optical receiver includes a non-linear signal distortion compensation unit that multiplies the transmission signal by a value representing an inverse characteristic of a gain coefficient of non-linear signal distortion generated in the transmission signal by a semiconductor optical amplifier, a non-linear signal distortion estimation unit that estimates non-linear signal distortion, and a physical parameter estimation unit that estimates physical parameters of the semiconductor optical amplifier. The optical receiver switches an output destination such that the reception signal is output to the non-linear signal distortion estimation unit in a case where the optical transmitter is operating in the first operation mode, and switches the output destination such that the reception signal is output to the reception data demodulation unit in a case where the optical transmitter is operating in the second operation mode.

### TECHNICAL FIELD

The present invention relates to an optical transmission system and a signal distortion compensation method.

### BACKGROUND ART

In order to reduce a size and power consumption of an optical transmission system, an optical transceiver to which a semiconductor optical amplifier (SOA) is applied has been developed. In such an optical transceiver, non-linear distortion occurs in a signal when the signal is amplified in a semiconductor optical amplifier. Thus, a technique for compensating distortion due to a semiconductor optical amplifier by digital signal processing has been proposed (see, for example, Patent Literature 1).

Non-linear distortion generated by a semiconductor optical amplifier can be reduced by increasing a symbol rate of a signal. However, as described in Non Patent Literature 1, in an ultra-high symbol rate signal of 168 GBaud, a signal to noise ratio (SNR) penalty of about 1 dB occurs. In order to implement high-quality communication, a highly accurate compensation technique in signal processing is required also for a high symbol rate signal.

### CITATION LIST

### Non Patent Literature

Non Patent Literature 1: F. Hamaoka, et al., “Experimental Investigation of Influence of SOA-Induced Nonlinear Distortion on High-Symbol-Rate 168-GBaud Signal for Achieving Ultra-Broadband Optical Frontend”, in Proceedings Optical Fiber Communication Conference (OFC), San Diego, CA, USA, 2022, M3H.2.

### Patent Literature

Patent Literature 1: JP 6633470 B

### SUMMARY OF INVENTION

### Technical Problem

In the technique described in Patent Literature 1, a gain coefficient of distortion due to a semiconductor optical amplifier is calculated on the basis of physical parameters of the semiconductor optical amplifier estimated using a reception signal, and a signal is multiplied by an inverse characteristic of the calculated gain coefficient to compensate for non-linear signal distortion. However, in a case where the non-linear distortion generated by the semiconductor optical amplifier is small as in the case of a high symbol rate signal, estimation accuracy of the physical parameters of the semiconductor optical amplifier degrades. Thus, there is a problem that compensation accuracy of the non-linear distortion generated by the semiconductor optical amplifier degrades.

In view of the above circumstances, an object of the present invention is to provide a technique capable of improving compensation accuracy of non-linear distortion generated by a semiconductor optical amplifier.

### Solution to Problem

One aspect of the present invention is an optical transmission system including an optical transmitter and an optical receiver, in which the optical transmitter includes an operation mode control unit that sets one of operation modes of a first operation mode for generating a signal of a low symbol rate and a second operation mode for generating a signal of a high symbol rate, and a transmission signal generation unit that generates a transmission signal according to the operation mode set by the operation mode control unit, the optical receiver includes an optical coherent receiver that acquires an optical signal based on the transmission signal and generates a reception signal based on the optical signal, a digital signal processing unit that performs digital signal processing on the reception signal, and a reception data demodulation unit that demodulates binary information of a transmission data sequence on the basis of the reception signal subjected to the digital signal processing, and the optical transmitter or the optical receiver includes: a non-linear signal distortion compensation unit that calculates a gain coefficient of non-linear signal distortion generated in a transmission signal by a semiconductor optical amplifier on the basis of estimated values of physical parameters of the semiconductor optical amplifier and multiplies the transmission signal by a value representing an inverse characteristic of the gain coefficient; a non-linear signal distortion estimation unit that acquires the transmission signal and estimates the non-linear signal distortion on the basis of a comparison result between the transmission signal and the reception signal; and a physical parameter estimation unit that estimates the physical parameters of the semiconductor optical amplifier on the basis of the non-linear signal distortion estimated by the non-linear signal distortion estimation unit, and the optical receiver switches an output destination such that the reception signal subjected to the digital signal processing is output to the non-linear signal distortion estimation unit in a case where the optical transmitter is operating in the first operation mode, and switches an output destination such that the reception signal subjected to the digital signal processing is output to the reception data demodulation unit in a case where the optical transmitter is operating in the second operation mode.

One aspect of the present invention is a signal distortion compensation method to be performed by an optical transmission system including an optical transmitter and an optical receiver, and the signal distortion compensation method includes the optical transmitter setting one of operation modes of a first operation mode for generating a signal of a low symbol rate and a second operation mode for generating a signal of a high symbol rate, the optical transmitter generating a transmission signal according to the set operation mode, the optical receiver acquiring an optical signal based on the transmission signal and generating a reception signal based on the optical signal, the optical receiver performing digital signal processing on the reception signal, the optical receiver demodulating binary information of a transmission data sequence on the basis of the reception signal subjected to the digital signal processing, and the optical transmitter or the optical receiver calculating a gain coefficient of non-linear signal distortion generated in a transmission signal by a semiconductor optical amplifier on the basis of estimated values of physical parameters of the semiconductor optical amplifier, multiplying the transmission signal by a value representing an inverse characteristic of the gain coefficient, acquiring the transmission signal and estimating the non-linear signal distortion on the basis of a comparison result between the transmission signal and the reception signal, and estimating the physical parameters of the semiconductor optical amplifier on the basis of the estimated non-linear signal distortion, and the optical receiver switching an output destination such that the reception signal subjected to the digital signal processing is output to a non-linear signal distortion estimation unit that estimates the non-linear signal distortion in a case where the optical transmitter is operating in the first operation mode, and switching an output destination such that the reception signal subjected to the digital signal processing is output to a reception data demodulation unit that demodulates the binary information of the transmission data sequence in a case where the optical transmitter is operating in the second operation mode.

### Advantageous Effects of Invention

According to the present invention, it is possible to improve compensation accuracy of non-linear distortion generated by a semiconductor optical amplifier.

### BRIEF DESCRIPTION OF DRAWINGS

FIG. 1 A view illustrating a configuration example of an optical transceiver in a first embodiment.

FIG. 2 A view illustrating a configuration example of a transmission signal generation unit in the first embodiment.

FIG. 3 A sequence diagram indicating flow of processing of the optical transmission system in the first embodiment.

FIG. 4 A sequence diagram indicating flow of processing of the optical transmission system in the first embodiment.

FIG. 5 A view illustrating a configuration example of an optical transceiver in a second embodiment.

FIG. 6 A view illustrating a configuration example of an optical transceiver in a third embodiment.

FIG. 7 A view illustrating a configuration example of an optical transceiver in a fourth embodiment.

FIG. 8 A view indicating relationships between an injection current, physical parameters, and a linewidth-enhancement factor α.

FIG. 9 A view for explaining effects in the fourth embodiment.

FIG. 10 A view illustrating a constellation when an injection current of a semiconductor optical amplifier is 350 mA in a high symbol rate signal of 168 GBaud.

FIG. 11 A view illustrating a configuration example of an optical transceiver in a fifth embodiment.

### DESCRIPTION OF EMBODIMENTS

Hereinafter, embodiments of the present invention will be described with reference to the drawings.

### First Embodiment

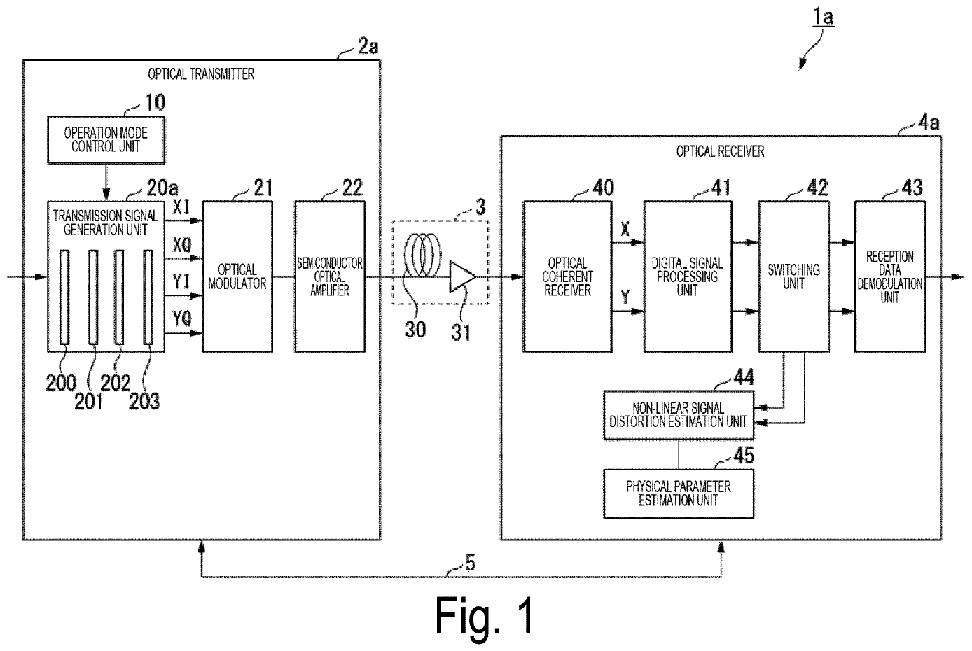

FIG. 1 is a view illustrating a configuration example of an optical transceiver 1a in a first embodiment. The optical transceiver 1a (optical transmission system) is a communication device using an optical signal. The optical transceiver 1a includes an optical transmitter 2a, a transmission path 3, an optical receiver 4a, and a control channel 5. The optical transmitter 2a is a communication device that transmits an optical signal. The optical transmitter 2a operates in a plurality of operation modes. For example, the optical transmitter 2a operates by switching between a first operation mode and a second operation mode. The first operation mode is an operation mode to be used when physical parameters of a semiconductor optical amplifier are estimated. In a case where the optical transmitter 2a operates in the first operation mode, the optical transmitter 2a generates a low symbol rate signal. The second operation mode is an operation mode to be used after the physical parameters of the semiconductor optical amplifier are estimated. In a case where the optical transmitter 2a operates in the second operation mode, the optical transmitter 2a generates a high symbol rate signal. In the following description, a case will be described as an example where the low symbol rate signal is a signal of 42 GBaud and the high symbol rate signal is a signal of 168 GBaud. Note that the low symbol rate signal and the high symbol rate signal are not limited to the above example. The optical receiver 4a may include a semiconductor optical amplifier 22. The transmission path 3 may include the semiconductor optical amplifier 22.

The optical transmitter 2a includes an operation mode control unit 10, a transmission signal generation unit 20a, an optical modulator 21, and the semiconductor optical amplifier 22. Note that the optical transmitter 2a includes the semiconductor optical amplifier 22 built in or externally attached thereto.

The operation mode control unit 10 controls the operation mode of the optical transmitter 2a. Specifically, the operation mode control unit 10 sets, in the optical transmitter 2a, whether to operate in the first operation mode or in the second operation mode as the operation mode of the optical transmitter 2a.

The transmission signal generation unit 20a generates a modulation signal sequence (XI, XQ, YI, YQ) on the basis of a transmission data sequence which is binary information. The transmission signal generation unit 20a generates modulation signal sequences (XI, XQ, YI, YQ) having different symbol rates according to the operation mode set by the operation mode control unit 10. For example, in a case where the operation mode set by the operation mode control unit 10 is the first operation mode, the transmission signal generation unit 20a generates a modulation signal sequence (XI, XQ, YI, YQ) signal having a low symbol rate (hereinafter, referred to as a “low symbol rate signal”). For example, in a case where the operation mode set by the operation mode control unit 10 is the second operation mode, the transmission signal generation unit 20a generates a modulation signal sequence (XI, XQ, YI, YQ) signal having a high symbol rate (hereinafter, referred to as a “high symbol rate signal”).

The optical modulator 21 includes a driver amplifier, a laser module, and a polarization-multiplexed Mach-changer type vector modulator (polarization-multiplexed IQ modulator). The driver amplifier amplifies an amplitude of the transmission signal for each lane. The optical modulator 21 may include a direct modulation light source instead of the laser module. The optical modulator 21 may be an intensity modulator. The optical modulator 21 modulates the modulation signal sequence. The optical modulator 21 outputs a polarization-multiplexed optical modulation signal to the semiconductor optical amplifier 22. Note that the optical modulator 21 may output an optical modulation signal of single polarization to the semiconductor optical amplifier 22.

The semiconductor optical amplifier 22 acquires the modulated optical signal (optical modulation signal) from the optical modulator 21. The semiconductor optical amplifier 22 amplifies intensity of the optical modulation signal. In the semiconductor optical amplifier 22, gain fluctuation occurs depending on the intensity of the optical modulation signal in association with carrier recombination in the semiconductor. Thus, non-linear signal distortion due to a pattern effect occurs in the optical signal, and signal characteristics degrade. The semiconductor optical amplifier 22 outputs the optical modulation signal in which the non-linear signal distortion occurs to the optical receiver 4a via the transmission path 3.

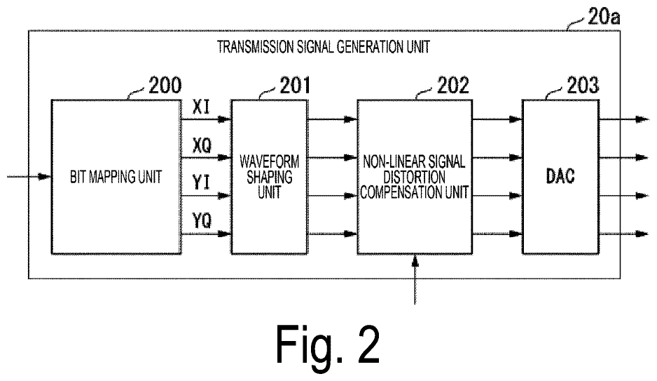

As illustrated in FIG. 2, the transmission signal generation unit 20a includes a bit mapping unit 200, a waveform shaping unit 201, a non-linear signal distortion compensation unit 202, and a digital-to-analog converter (DAC) 203. FIG. 2 is a view illustrating a configuration example of the transmission signal generation unit 20a in the first embodiment.

The bit mapping unit 200 acquires a transmission data sequence. The bit mapping unit 200 allocates transmission bits of the transmission data sequence to symbol points of a modulation scheme according to the operation mode. For example, the bit mapping unit 200 uses quadrature phase shift keying (QPSK), quadrature amplitude modulation (16 QAM), or the like, as the modulation scheme. The symbol points may be symbol points in a modulation format other than QPSK or 16 QAM.

The waveform shaping unit 201 executes filtering processing using a raised cosine filter, a root raised cosine filter, or the like, on the transmission signal. The waveform shaping unit 201 may execute pre-position signal compensation such as pre-position wavelength dispersion compensation or pre-position non-linear optical effect compensation. The waveform shaping unit 201 may execute compensation for frequency characteristics in an electric circuit or the optical modulator 21.

The non-linear signal distortion compensation unit 202 acquires the transmission signal from the waveform shaping unit 201. In the first embodiment, the non-linear signal distortion compensation unit 202 acquires estimated values of physical parameters of the semiconductor optical amplifier 22 from the optical receiver 4a. The non-linear signal distortion compensation unit 202 estimates non-linear signal distortion generated by the semiconductor optical amplifier 22 in an unknown transmission signal on the basis of the estimated values of the physical parameters of the semiconductor optical amplifier 22 and compensates for the non-linear signal distortion.

The non-linear signal distortion compensation unit 202 calculates a gain coefficient h(t) of non-linear signal distortion generated in the transmission signal by the semiconductor optical amplifier 22 on the basis of the estimated values of the physical parameters of the semiconductor optical amplifier 22. The non-linear signal distortion compensation unit 202 calculates a value (exp ((−h(t)(1+jα))/2)) representing an inverse characteristic of the gain coefficient h(t) of the non-linear signal distortion by using a gain coefficient −h(t) having the inverse characteristic of the gain coefficient h(t) of the non-linear signal distortion. The non-linear signal distortion compensation unit 202 multiplies the transmission signal by a value (exp((−h(t)(1+jα))/2)) representing the inverse characteristic of the gain coefficient h(t) of the non-linear signal distortion. As a result, the non-linear signal distortion compensation unit 202 can preequalize the non-linear signal distortion generated in the transmission signal by the semiconductor optical amplifier 22.

Note that in a case where the optical transmitter 2a operates in the first operation mode, the non-linear signal distortion compensation unit 202 sets the gain coefficient h(t) to 0. In a case where the optical transmitter 2a operates in the second operation mode, the non-linear signal distortion compensation unit 202 calculates the gain coefficient h(t) on the basis of the estimated values of the physical parameters of the semiconductor optical amplifier 22.

A relationship between the optical signal acquired by the semiconductor optical amplifier 22 and the optical signal output by the semiconductor optical amplifier 22 is represented by a physical model indicated in expression (1).

$$\begin{matrix}[ Math . 1 ] & \\ {E}_{o} ( t ) = {E}_{I} ( t ) exp ( \frac{h ( t ) ( 1 + j α )}{2} ) & ( 1 )\end{matrix}$$

Here, E_{I}(t) indicated in expression (1) represents a complex amplitude of the optical signal (the transmission signal of the transmission signal generation unit 20a) acquired by the semiconductor optical amplifier 22. Eₒ(t) indicated in expression (1) represents a complex amplitude of the optical signal (the reception signal of the optical receiver 4a) transmitted by the semiconductor optical amplifier 22. h(t) indicated in expression (1) represents a gain coefficient. a indicated in expression (1) represents a linewidth-enhancement factor. j indicated in expression (1) represents an imaginary unit. exp(h(t)(1+jα)/2) indicated in expression (1) represents non-linear signal distortion generated in the transmission signal by the semiconductor optical amplifier 22.

In the physical model indicated in expression (1), the gain coefficient h(t) is expressed by a differential equation indicated in expression (2).

$$\begin{matrix}[ Math . 2 ] & \\ {τ}_{c} \frac{d}{dt} h ( t ) = {h}_{0} - h ( t ) - [ exp ( h ( t ) ) - 1 ] \frac{{\vert {E}_{I} ( t ) \vert}^{2}}{{P}_{sat}} & ( 2 )\end{matrix}$$

Here, τ_{c} indicated in expression (2) represents a carrier lifetime. h₀ indicated in expression (2) represents a non-saturation gain. Pₛₐₜ indicated in expression (2) represents a saturation output. These are the physical parameters of the semiconductor optical amplifier 22, along with the linewidth-enhancement factor α indicated in expression (1). In the physical model indicated in expression (1), if these physical parameters are obtained, behavior of the non-linear signal distortion generated in the transmission signal by the semiconductor optical amplifier 22 can be expressed.

Expression (2) indicates that temporal change of the gain coefficient h(t) depends on power of the optical signal acquired by the semiconductor optical amplifier 22. Thus, if the physical parameters of the semiconductor optical amplifier 22 are known, the gain coefficient h(t) depending on power of the optical signal can be obtained from expression (2).

The non-linear signal distortion compensation unit 202 can obtain the gain coefficient h(t) as a numerical solution from expression (2) by, for example, a time evolution solution by an Euler method or an N-order (N is a positive integer) Rungecutter method. In a case where the gain coefficient h(t) is obtained from expression (2), the non-linear signal distortion compensation unit 202 may use an analysis solution if the analysis solution exists.

The non-linear signal distortion compensation unit 202 calculates a value (exp(−h(t)(1+jα)/2)) representing an inverse characteristic of the gain coefficient h(t) of non-linear signal distortion by using the gain coefficient (−h(t)) having the inverse characteristic of the gain coefficient h(t).

The non-linear signal distortion compensation unit 202 compensates for the non-linear signal distortion generated in the transmission signal by the semiconductor optical amplifier 22 by multiplying the transmission signal E_{I}(t) by a value (exp(−h(t)(1+jα)/2)) representing the inverse characteristic of the gain coefficient h(t) of the non-linear signal distortion. As a result, the non-linear signal distortion compensation unit 202 can preequalize the non-linear signal distortion generated in the transmission signal by the semiconductor optical amplifier 22.

Note that the non-linear signal distortion compensation unit 202 may obtain the gain coefficient h(t) from expression (2) by a solution other than the time evolution solution. In a case where the optical transmitter 2a operates in the first operation mode, the transmission signal may be input to the DAC 203 while bypassing the non-linear signal distortion compensation unit 202. In other words, in a case where the optical transmitter 2a operates in the first operation mode, the transmission signal may be directly output from the waveform shaping unit 201 to the DAC 203 without passing through the non-linear signal distortion compensation unit 202.

The DAC 203 converts a digital signal into an analog signal. The DAC 203 outputs a transmission signal that is an analog signal to the optical modulator 21.

Referring back to FIG. 1, the description will be continued.

The transmission path 3 includes an optical fiber 30 and an optical amplifier 31. The transmission path 3 may further include a path switching unit for switching a path of an optical signal. The optical fiber 30 transmits an optical signal (for example, an optical modulation signal). The optical amplifier 31 amplifies intensity of an optical signal.

The optical receiver 4a is a communication device that receives an optical signal. The optical receiver 4a includes an optical coherent receiver 40, a digital signal processing unit 41, a switching unit 42, a reception data demodulation unit 43, a non-linear signal distortion estimation unit 44, and a physical parameter estimation unit 45. The optical receiver 4a further includes a laser module.

The optical coherent receiver 40 converts the optical signal transmitted through the transmission path 3 into a reception signal (baseband signal) that is an analog signal using local light emitted by the laser module.

The digital signal processing unit 41 converts a reception signal that is an analog signal into a reception signal that is a digital signal. The digital signal processing unit 41 compensates for waveform degradation due to wavelength dispersion, polarization fluctuation, and a non-linear optical effect generated in the optical signal in the transmission path 3 by digital signal processing. The digital signal processing unit 41 compensates for a frequency error between a laser of the optical transmitter 2a and a laser of the optical receiver 4a and phase noise due to line widths of the lasers of the optical transmitter 2a and the optical receiver 4a by digital signal processing.

The switching unit 42 switches a path of an output destination of the reception signal output from the digital signal processing unit 41 according to the operation mode of the optical transmitter 2a. The switching unit 42 is, for example, a switch. In a case where the optical transmitter 2a is operating in the first operation mode, the switching unit 42 switches the path so as to connect the digital signal processing unit 41 and the non-linear signal distortion estimation unit 44. As a result, the switching unit 42 outputs the reception signal output from the digital signal processing unit 41 to the non-linear signal distortion estimation unit 44. As described above, in a case where the optical transmitter 2a is operating in the first operation mode, the switching unit 42 outputs the reception signal to the non-linear signal distortion estimation unit 44 in order to estimate the physical parameters of the semiconductor optical amplifier 22.

In a case where the optical transmitter 2a is operating in the second operation mode, the switching unit 42 switches the path so as to connect the digital signal processing unit 41 and the reception data demodulation unit 43. As a result, the switching unit 42 outputs the reception signal output from the digital signal processing unit 41 to the reception data demodulation unit 43. The operation mode of the optical transmitter 2a may be notified from the optical transmitter 2a via the control channel 5, which is a communication channel, a network element-operations system (NE-OpS), a network-operations system (NW-OpS), or the like, or may be notified to the optical receiver 4a using an external device. The switching unit 42 may be incorporated in the digital signal processing unit 41.

The reception data demodulation unit 43 acquires the reception signal in which the waveform degradation is compensated from the switching unit 42. The reception data demodulation unit 43 demodulates binary information of a transmission data sequence on the basis of the reception signal that is a digital signal.

The non-linear signal distortion estimation unit 44 acquires the reception signal, which is a digital signal based on the transmission signal of the optical transmitter 2a, from the switching unit 42. The non-linear signal distortion estimation unit 44 acquires the transmission signal of the optical transmitter 2a from the optical transmitter 2a as a reference signal. For example, the non-linear signal distortion estimation unit 44 acquires the transmission signal of the optical transmitter 2a as the reference signal from the optical transmitter 2a via the control channel 5. For example, the non-linear signal distortion estimation unit 44 acquires part of a known signal of the transmission data sequence from the optical transmitter 2a as the reference signal. For example, in the non-linear signal distortion estimation unit 44, for example, the non-linear signal distortion estimation unit 44 acquires a sequence of values of symbols of the reception signal from the optical transmitter 2a as the reference signal.

The non-linear signal distortion estimation unit 44 obtains a value (exp(h(t)(1+jα)/2)) representing the non-linear signal distortion generated in the transmission signal by the semiconductor optical amplifier 22 and the linewidth-enhancement factor α as in expression (3) on the basis of a result of dividing the measured optical signal Eₒ(t) by the optical signal E_{I}(t) and expression (1).

$$\begin{matrix}[ Math . 3 ] & \\ \frac{{E}_{o} ( t )}{{E}_{I} ( t )} = exp ( \frac{h ( t ) ( 1 + j α )}{2} ) & ( 3 )\end{matrix}$$

The non-linear signal distortion estimation unit 44 may calculate an average value of the same symbols using the reference signal as a repetitive signal. As a result, the non-linear signal distortion estimation unit 44 can reduce signal distortion due to white noise. The non-linear signal distortion estimation unit 44 can increase estimation accuracy of the non-linear signal distortion. In a case where the non-linear signal distortion due to the semiconductor optical amplifier 22 is large, the non-linear signal distortion estimation unit 44 may not be able to accurately estimate the non-linear signal distortion due to degradation in signal quality. The non-linear signal distortion estimation unit 44 may repeat estimation by feeding back a value estimated once. As a result, the non-linear signal distortion estimation unit 44 can compensate for a transfer function with higher accuracy even in a case where the non-linear signal distortion generated by the semiconductor optical amplifier 22 is large.

The measured values of the physical parameters of the semiconductor optical amplifier 22 may be different from design values of the physical parameters of the semiconductor optical amplifier 22 due to individual differences caused by a manufacturing error, or the like, of the semiconductor optical amplifier 22. Thus, the physical parameter estimation unit 45 estimates the physical parameters of the semiconductor optical amplifier 22 by digital signal processing. As a result, the non-linear signal distortion compensation unit 202 of the optical transmitter 2a can compensate for the non-linear signal distortion by absorbing individual differences of the semiconductor optical amplifier 22 of the optical transmitter 2a. The non-linear signal distortion compensation unit 202 can also compensate for the non-linear signal distortion of the semiconductor optical amplifier 22 having unknown physical parameters. The physical parameter estimation unit 45 estimates the physical parameters of the semiconductor optical amplifier 22 on the basis of a result of the non-linear signal distortion estimation unit 44 estimating the non-linear signal distortion on the basis of the reference signal.

The physical parameter estimation unit 45 estimates the physical parameters of the semiconductor optical amplifier 22 on the basis of the gain coefficient h(t) obtained using expression (3) and expression (2). The physical parameters of the semiconductor optical amplifier 22 are, for example, a carrier lifetime τ_{c}, a non-saturation gain h₀, and a saturation output Pₛₐₜ. Specifically, the physical parameter estimation unit 45 obtains the carrier life τ_{c}, the non-saturation gain h₀, and the saturation output Pₛₐₜ by minimizing a sum of squares of the residuals indicated in expression (4) using a least squares method from a discrete formula of expression (2).

$$\begin{matrix}[ Math . 4 ] & \\ ε ( {τ}_{c} , {h}_{0} , {P}_{sat} ) = {\sum }_{n} {( {τ}_{c} \frac{h ( n + 1 ) - h ( n - 1 )}{2 Δ t} - ( {h}_{0} - h ( n ) - ( exp ( h ( n ) ) - 1 ) \frac{{\vert {E}_{I} ( n ) \vert}^{2}}{{P}_{sat}} ) )}^{2} & ( 4 )\end{matrix}$$

A method by which the physical parameter estimation unit 45 estimates the physical parameters of the semiconductor optical amplifier 22 is not limited to a specific method. For example, the physical parameter estimation unit 45 may estimate the physical parameters of the semiconductor optical amplifier 22 by fitting by a least squares method, calculation by simultaneous equations, or the like.

The physical parameter estimation unit 45 feeds back the physical parameters of the semiconductor optical amplifier 22 to the non-linear signal distortion compensation unit 202 through the control channel 5.

Note that, in a case where the optical transmitter 2a and the optical receiver 4a are directly connected by a dedicated line, the physical parameter estimation unit 45 may estimate the physical parameters of the semiconductor optical amplifier 22 on the basis of an optical signal transmitted through the dedicated line instead of the transmission path 3. After estimating the physical parameters of the semiconductor optical amplifier 22, the physical parameter estimation unit 45 can transmit a signal obtained by deleting the reference signal from the transmission signal to which the reference signal has been added to the optical transmitter 2a and the reception data demodulation unit 43. Thereafter, in a case where it is necessary to estimate the physical parameters again, the physical parameter estimation unit 45 may add the reference signal to the transmission signal again. In a case where a current to be injected into the semiconductor optical amplifier 22 does not change or in a case where intensity of the optical signal acquired by the semiconductor optical amplifier 22 does not change, the physical parameter estimation unit 45 can continuously use the estimation result of the physical parameters of the semiconductor optical amplifier 22. In these cases, the physical parameter estimation unit 45 may temporarily stop estimation of the physical parameters of the semiconductor optical amplifier 22 or may continuously and periodically calculate the physical parameters of the semiconductor optical amplifier 22. In a case where the current to be injected into the semiconductor optical amplifier 22 changes or in a case where the intensity of the optical signal acquired by the semiconductor optical amplifier 22 changes, the physical parameter estimation unit 45 calculates the physical parameters of the semiconductor optical amplifier 22 again.

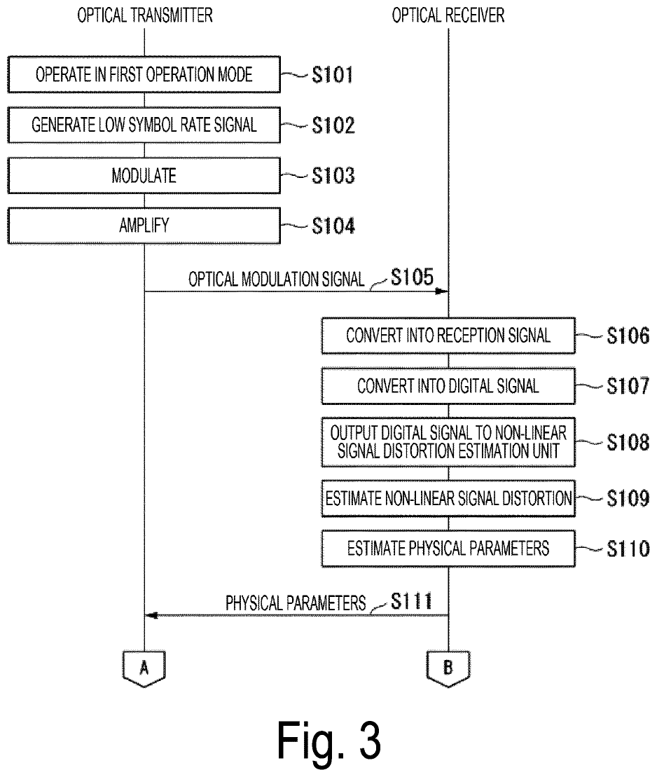

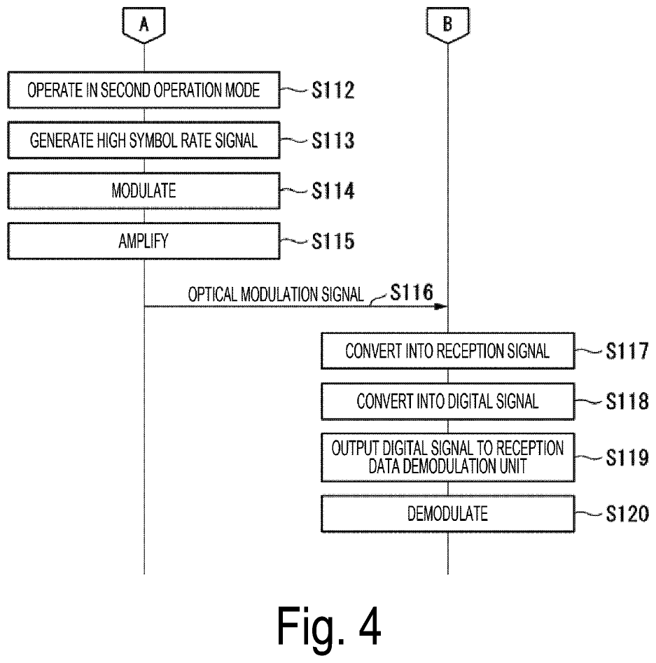

FIGS. 3 and 4 are sequence diagrams illustrating flow of processing of the optical transmission system in the first embodiment.

The operation mode control unit 10 sets the operation mode of the optical transmitter 2a to the first operation mode according to an instruction from the outside (step S101). Note that the optical transmitter 2a may notify the optical receiver 4a of information on the operation mode in response to setting of the operation mode by the operation mode control unit 10. The operation mode set by the operation mode control unit 10 is the first operation mode, and thus, the transmission signal generation unit 20a generates a low symbol rate signal (step S102). The optical transmitter 2a is operating in the first operation mode, and thus, the non-linear signal distortion compensation unit 202 performs processing while setting the gain coefficient h(t) of the non-linear signal distortion to 0. The transmission signal generation unit 20a outputs the generated low symbol rate signal to the optical modulator 21.

The optical modulator 21 generates an optical modulation signal by modulating the low symbol rate signal output from the transmission signal generation unit 20a (step S103). The optical modulator 21 outputs the generated optical modulation signal to the semiconductor optical amplifier 22. The semiconductor optical amplifier 22 amplifies intensity of the optical modulation signal output from the optical modulator 21 (step S104). The semiconductor optical amplifier 22 transmits the amplified optical modulation signal to the optical receiver 4a via the transmission path 3 (step S105).

The optical coherent receiver 40 of the optical receiver 4a converts the optical modulation signal transmitted through the transmission path 3 into a reception signal (baseband signal) that is an analog signal using local light emitted by the laser module (step S106). The optical coherent receiver 40 outputs the converted reception signal to the digital signal processing unit 41. The digital signal processing unit 41 converts the reception signal output from the optical coherent receiver 40 into a reception signal that is a digital signal (step S107). The digital signal processing unit 41 outputs the reception signal that is a digital signal to the switching unit 42.

The switching unit 42 is notified that the optical transmitter 2a is operating in the first operation mode. Thus, the switching unit 42 outputs the reception signal output from the digital signal processing unit 41 to the non-linear signal distortion estimation unit 44 (step S108). The non-linear signal distortion estimation unit 44 estimates non-linear signal distortion on the basis of the reception signal output from the switching unit 42 (step S109). The non-linear signal distortion estimation unit 44 outputs an estimation result of the non-linear signal distortion to the physical parameter estimation unit 45. The physical parameter estimation unit 45 estimates the physical parameters of the semiconductor optical amplifier 22 on the basis of the result of the non-linear signal distortion estimation unit 44 estimating the non-linear signal distortion on the basis of the reference signal (step S110). The physical parameter estimation unit 45 notifies the optical transmitter 2a of the estimated physical parameters of the semiconductor optical amplifier 22 via the control channel 5 (step S111).

The operation mode control unit 10 sets the operation mode of the optical transmitter 2a to the second operation mode according to an instruction from the outside (step S112). Note that the optical transmitter 2a may notify the optical receiver 4a of information on the operation mode in response to setting of the operation mode by the operation mode control unit 10. The operation mode set by the operation mode control unit 10 is the second operation mode, and thus, the transmission signal generation unit 20a generates a high symbol rate signal (step S113). The optical transmitter 2a is operating in the second operation mode, and thus, the non-linear signal distortion compensation unit 202 estimates the non-linear signal distortion on the basis of the estimated values of the physical parameters of the semiconductor optical amplifier 22 notified from the optical receiver 4a and compensates for the non-linear signal distortion. The transmission signal generation unit 20a outputs the generated high symbol rate signal to the optical modulator 21.

The optical modulator 21 generates an optical modulation signal by modulating the high symbol rate signal output from the transmission signal generation unit 20a (step S114). The optical modulator 21 outputs the generated optical modulation signal to the semiconductor optical amplifier 22. The semiconductor optical amplifier 22 amplifies intensity of the optical modulation signal output from the optical modulator 21 (step S115). The semiconductor optical amplifier 22 transmits the amplified optical modulation signal to the optical receiver 4a via the transmission path 3 (step S116).

The optical coherent receiver 40 of the optical receiver 4a converts the optical modulation signal transmitted through the transmission path 3 into a reception signal (baseband signal) that is an analog signal using local light emitted by the laser module (step S117). The optical coherent receiver 40 outputs the converted reception signal to the digital signal processing unit 41. The digital signal processing unit 41 converts the reception signal output from the optical coherent receiver 40 into a reception signal that is a digital signal (step S118). The digital signal processing unit 41 outputs the reception signal that is a digital signal to the switching unit 42.

The switching unit 42 is notified that the optical transmitter 2a is operating in the second operation mode. Thus, the switching unit 42 outputs the reception signal output from the digital signal processing unit 41 to the reception data demodulation unit 43 (step S119). The reception data demodulation unit 43 demodulates binary information of a transmission data sequence on the basis of the reception signal output from the switching unit 42 (step S120).

According to the optical transceiver 1a of the first embodiment configured as described above, it is possible to improve compensation accuracy of non-linear distortion generated by the semiconductor optical amplifier 22. Specifically, in the optical transceiver 1a, in a case where the optical transmitter 2a operates in the first operation mode, an optical signal based on a low symbol rate signal is transmitted to the optical receiver 4a. The optical receiver 4a estimates non-linear signal distortion of the semiconductor optical amplifier 22 generated when the signal is amplified by the semiconductor optical amplifier 22 on the basis of the optical signal based on the low symbol rate signal. Then, the optical receiver 4a estimates the physical parameters of the semiconductor optical amplifier 22 on the basis of the estimated non-linear signal distortion. While the non-linear distortion generated by the semiconductor optical amplifier 22 decreases due to increase in the symbol rate of the signal, the non-linear distortion generated by the semiconductor optical amplifier 22 is larger in the low symbol rate signal than in the high symbol rate signal. As a result, the optical receiver 4a can accurately estimate the physical parameters of the semiconductor optical amplifier 22. Then, in the optical transmitter 2a, by accurately calculating the gain coefficient of the non-linear signal distortion when the high symbol rate signal is amplified by the semiconductor optical amplifier 22 using the physical parameters of the semiconductor optical amplifier 22 estimated with the low symbol rate signal, it is possible to improve compensation accuracy of the non-linear distortion generated by the semiconductor optical amplifier 22 of the high symbol rate signal.

### Second Embodiment

A second embodiment is different from the first embodiment in that the optical transmitter includes a physical parameter estimation unit 45. In the second embodiment, differences from the first embodiment will be mainly described.

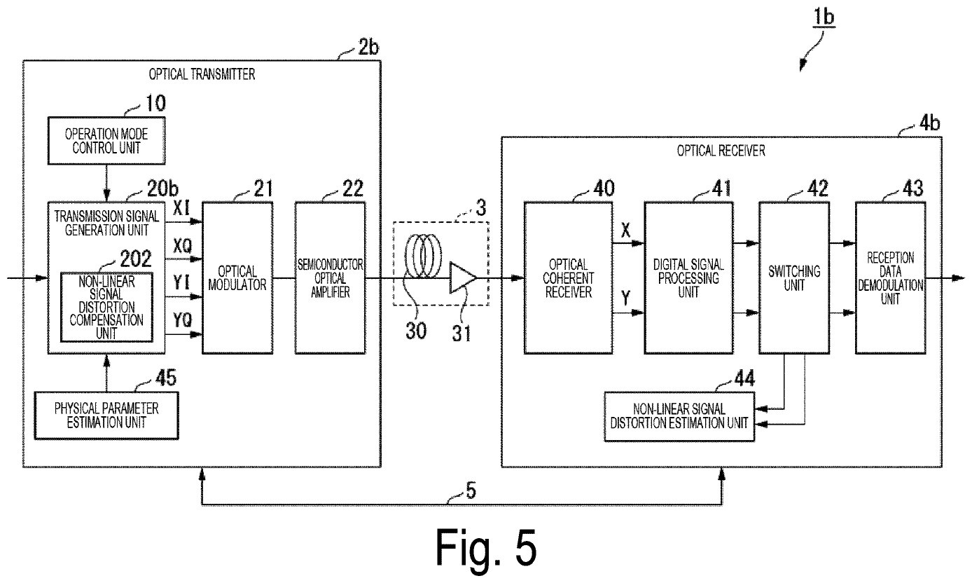

FIG. 5 is a view illustrating a configuration example of an optical transceiver 1b in the second embodiment. The optical transceiver 1b includes an optical transmitter 2b, the transmission path 3, an optical receiver 4b, and the control channel 5. The optical transmitter 2b includes the operation mode control unit 10, the transmission signal generation unit 20a, the optical modulator 21, the semiconductor optical amplifier 22, and the physical parameter estimation unit 45. Note that the optical transmitter 2b includes the semiconductor optical amplifier 22 built in or externally attached thereto. The optical receiver 4b includes the optical coherent receiver 40, the digital signal processing unit 41, the switching unit 42, the reception data demodulation unit 43, and the non-linear signal distortion estimation unit 44. The optical receiver 4b may include the semiconductor optical amplifier 22. The transmission path 3 may include the semiconductor optical amplifier 22.

The non-linear signal distortion estimation unit 44 transmits a gain coefficient h(t) and a linewidth-enhancement factor α, which are the estimation result of the non-linear signal distortion, to the physical parameter estimation unit 45 included in the optical transmitter 2b via the control channel 5.

The physical parameter estimation unit 45 estimates the physical parameters of the semiconductor optical amplifier 22 on the basis of a result of the non-linear signal distortion estimation unit 44 estimating the non-linear signal distortion on the basis of the reference signal.

According to the optical transceiver 1b of the first embodiment configured as described above, effects similar to those of the first embodiment can be obtained.

### Third Embodiment

A third embodiment is different from the second embodiment in that the optical transmitter includes the non-linear signal distortion estimation unit 44 and the physical parameter estimation unit 45. In the third embodiment, differences from the second embodiment will be mainly described.

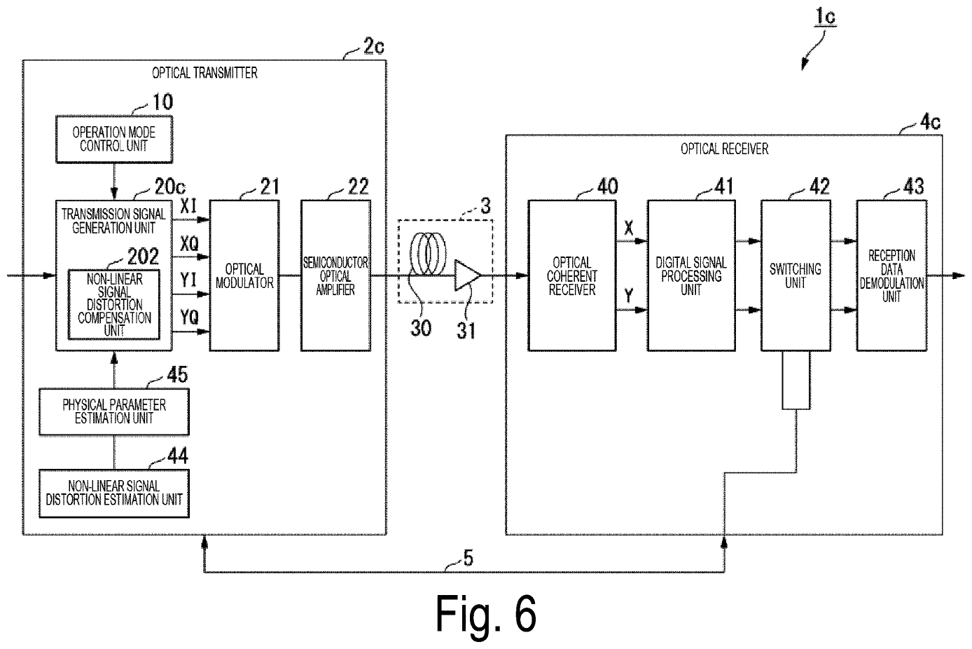

FIG. 6 is a view illustrating a configuration example of an optical transceiver 1c in the third embodiment. The optical transceiver 1c includes an optical transmitter 2c, the transmission path 3, an optical receiver 4c, and the control channel 5. The optical transmitter 2c includes the operation mode control unit 10, a transmission signal generation unit 20c, the optical modulator 21, the semiconductor optical amplifier 22, the non-linear signal distortion estimation unit 44, and the physical parameter estimation unit 45. Note that the optical transmitter 2c includes the semiconductor optical amplifier 22 built in or externally attached thereto. The optical receiver 4c includes the optical coherent receiver 40, the digital signal processing unit 41, the switching unit 42, and the reception data demodulation unit 43. The optical receiver 4c may include the semiconductor optical amplifier 22. The transmission path 3 may include the semiconductor optical amplifier 22.

In a case where the optical transmitter 2c operates in the first operation mode, the switching unit 42 transmits the reception signal output from the digital signal processing unit 41 to the non-linear signal distortion estimation unit 44 included in the optical transmitter 2c via the control channel 5. The non-linear signal distortion estimation unit 44 outputs the gain coefficient h(t) and the linewidth-enhancement coefficient α, which are the estimation result of the non-linear signal distortion, to the physical parameter estimation unit 45. The physical parameter estimation unit 45 estimates the physical parameters of the semiconductor optical amplifier 22 on the basis of a result of the non-linear signal distortion estimation unit 44 estimating the non-linear signal distortion on the basis of the reference signal.

According to the optical transceiver 1c of the third embodiment configured as described above, effects similar to those of the first embodiment can be obtained.

### Fourth Embodiment

A fourth embodiment is different from the first embodiment in that the optical receiver includes a non-linear signal distortion compensation unit 202 at a subsequent stage of the optical coherent receiver 40. In the fourth embodiment, differences from the first embodiment will be mainly described.

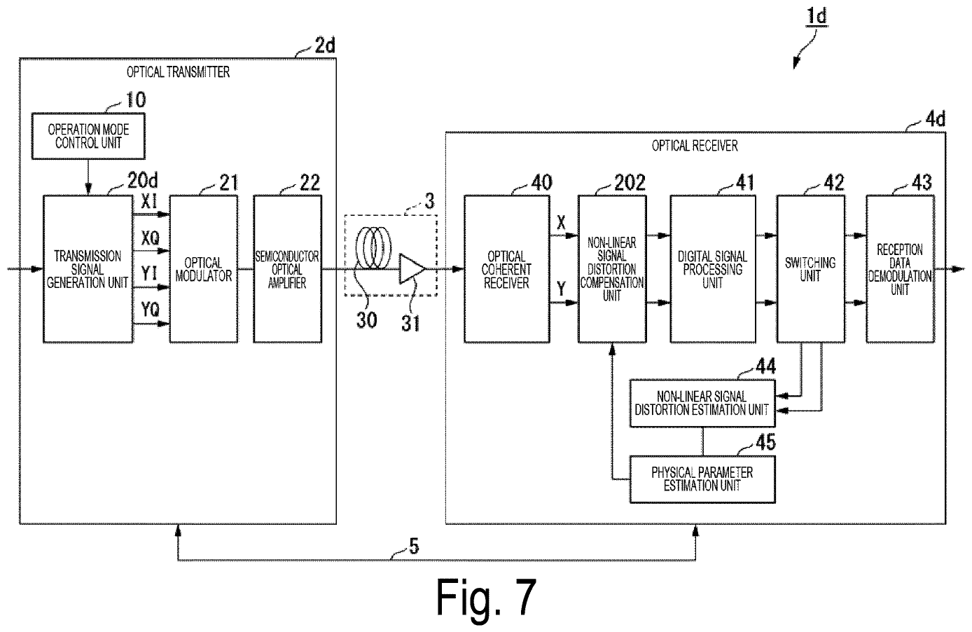

FIG. 7 is a view illustrating a configuration example of an optical transceiver 1d in the fourth embodiment. The optical transceiver 1d includes an optical transmitter 2d, the transmission path 3, an optical receiver 4d, and the control channel 5. The optical transmitter 2d includes the operation mode control unit 10, a transmission signal generation unit 20d, the optical modulator 21, and the semiconductor optical amplifier 22. The optical transmitter 2d includes the semiconductor optical amplifier 22 built in or externally attached thereto. The transmission signal generation unit 20d includes the bit mapping unit 200, the waveform shaping unit 201, and the DAC 203.

The optical receiver 4d includes the optical coherent receiver 40, the digital signal processing unit 41, the switching unit 42, the reception data demodulation unit 43, the non-linear signal distortion estimation unit 44, the physical parameter estimation unit 45, and the non-linear signal distortion compensation unit 202. The optical receiver 4d includes the non-linear signal distortion compensation unit 202 at a subsequent stage of the optical coherent receiver 40. The optical receiver 4d includes the digital signal processing unit 41 at a subsequent stage of the non-linear signal distortion compensation unit 202. The optical receiver 4d may include the semiconductor optical amplifier 22. The transmission path 3 may include the semiconductor optical amplifier 22.

The switching unit 42 switches a path of an output destination of the reception signal output from the digital signal processing unit 41 according to the operation mode of the optical transmitter 2d. The switching unit 42 is, for example, a switch. In a case where the optical transmitter 2d is operating in the first operation mode, the switching unit 42 switches the path so as to connect the digital signal processing unit 41 and the non-linear signal distortion estimation unit 44. As a result, the switching unit 42 outputs the reception signal output from the digital signal processing unit 41 to the non-linear signal distortion estimation unit 44. As described above, in a case where the optical transmitter 2d is operating in the first operation mode, the switching unit 42 outputs the reception signal to the non-linear signal distortion estimation unit 44 in order to estimate the physical parameters of the semiconductor optical amplifier 22.

In a case where the optical transmitter 2d is operating in the second operation mode, the switching unit 42 switches the path so as to connect the digital signal processing unit 41 and the reception data demodulation unit 43. As a result, the switching unit 42 outputs the reception signal output from the digital signal processing unit 41 to the reception data demodulation unit 43. The operation mode of the optical transmitter 2d may be notified from the optical transmitter 2d via the control channel 5 or may be notified to the optical receiver 4d using an external device. The switching unit 42 may be incorporated in the digital signal processing unit 41.

The non-linear signal distortion compensation unit 202 acquires the reception signal that is an analog signal from the optical coherent receiver 40. The non-linear signal distortion compensation unit 202 acquires the physical parameters of the semiconductor optical amplifier 22 from the physical parameter estimation unit 45.

The non-linear signal distortion compensation unit 202 compensates for non-linear signal distortion generated in the transmission signal by the semiconductor optical amplifier 22 by multiplying the reception signal Eₒ(t) by an analog signal in accordance with a value (exp(−h(t)(1+jα)/2)) representing an inverse characteristic of the gain coefficient h(t) of the non-linear signal distortion. As a result, the non-linear signal distortion compensation unit 202 can equalize the non-linear signal distortion generated in the transmission signal by the semiconductor optical amplifier 22.

In a case where the optical transmitter 2d operates in the first operation mode, the non-linear signal distortion compensation unit 202 sets the gain coefficient h(t) to 0. In a case where the optical transmitter 2d operates in the second operation mode, the non-linear signal distortion compensation unit 202 calculates the gain coefficient h(t) on the basis of the estimated values of the physical parameters of the semiconductor optical amplifier 22. The operation mode of the optical transmitter 2d may be notified from the optical transmitter 2d via the control channel 5 or may be notified to the optical receiver 4d using an external device. In a case where the operation mode of the optical transmitter 2d is not notified from the optical transmitter 2d via the control channel 5, the optical transceiver 1d does not have to include the control channel 5.

In a case where the non-linear signal distortion compensation unit 202 obtains the gain coefficient h(t) as a numerical solution from expression (2), the gain coefficient h(t) is obtained on the basis of the following expressions (5) to (9). The same applies to the first to third embodiments and the fifth embodiment which will be described later.

$$\begin{matrix}[ Math . 5 ] & \\ h ( n + 1 ) = h ( n ) + \frac{1}{6} ( {k}_{1} + 2 {k}_{2} + 2 {k}_{3} + {k}_{4} ) & ( 5 )\end{matrix}$$

$$\begin{matrix}[ Math . 6 ] & \\ {k}_{1} = f ( h ( n ) ) & ( 6 )\end{matrix}$$

$$\begin{matrix}[ Math . 7 ] & \\ {k}_{2} = f ( h ( n ) + {k}_{1} / 2 ) & ( 7 )\end{matrix}$$

$$\begin{matrix}[ Math . 8 ] & \\ {k}_{3} = f ( h ( n ) + {k}_{2} / 2 ) & ( 8 )\end{matrix}$$

$$\begin{matrix}[ Math . 9 ] & \\ {k}_{4} = f ( h ( n ) + {k}_{3} ) & ( 9 )\end{matrix}$$

Note that, as in the present embodiment, in a case where the gain coefficient h(t) is calculated on the optical receiver 4d side (in a case where the non-linear signal distortion compensation unit 202 is included in the optical receiver 4d), the non-linear signal distortion compensation unit 202 calculates the gain coefficient h(t) using the reception signal Eₒ instead of the transmission signal E_{I} in expression (10).

$$\begin{matrix}[ Math . 10 ] & \\ f ( u ) = \frac{Δ t}{{τ}_{c}} ( {h}_{0} - u - ( exp ( u ) - 1 ) \frac{{\vert {E}_{0} ( n ) \vert}^{2}}{{P}_{sat}} ) & ( 10 )\end{matrix}$$

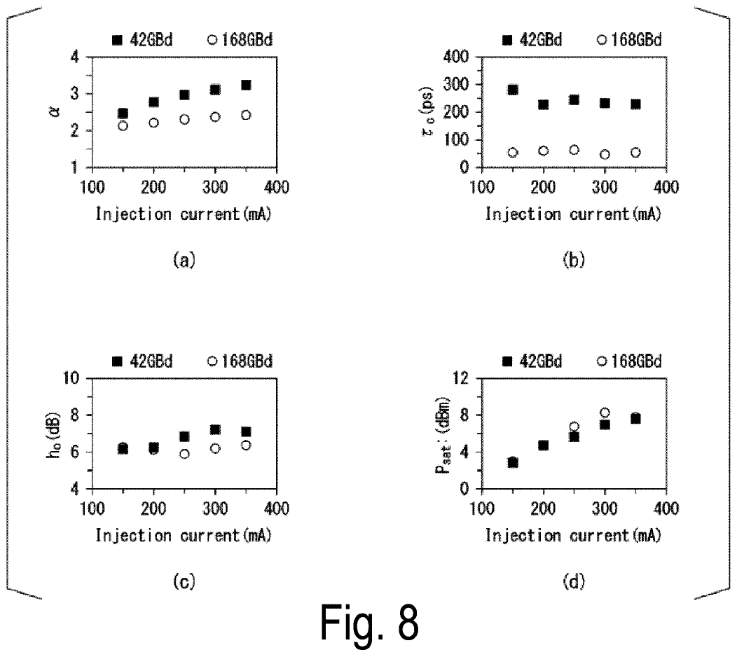

Next, effects of the present invention will be described. FIG. 8 is a view indicating relationships between an injection current, physical parameters, and a linewidth-enhancement factor α. Here, the injection current represents an injection current to the semiconductor optical amplifier 22. FIG. 8(a) indicates a relationship between the injection current (injection current) and the linewidth-enhancement factor α, FIG. 8(b) indicates a relationship between the injection current (injection current) and the carrier life 1c as the physical parameter, FIG. 8(c) indicates a relationship between the injection current (injection current) and the non-saturation gain h₀ as the physical parameter, and FIG. 8(d) indicates a relationship between the injection current (injection current) and the saturation output Pₛₐₜ as the physical parameter.

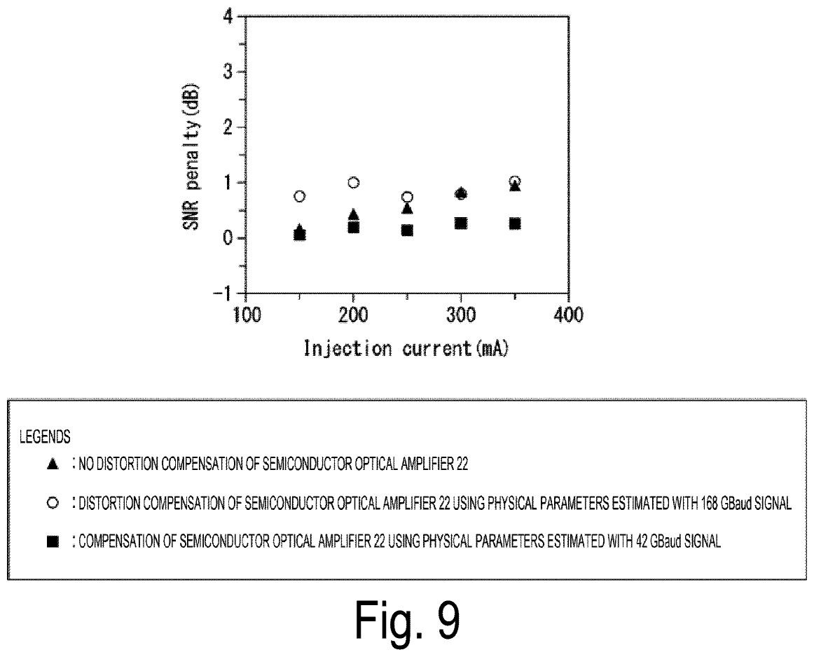

FIG. 9 is a view for explaining effects of the present invention. As illustrated in FIG. 9, in distortion compensation of the semiconductor optical amplifier 22 using the physical parameters estimated with the low symbol rate signal of 168 GBaud, an SNR penalty of 0.96 dB generated without distortion compensation of the semiconductor optical amplifier 22 for the high symbol rate signal of 42 GBaud can be reduced to 0.29 dB or less. Note that it can be seen that the SNR penalty is not improved in distortion compensation of the semiconductor optical amplifier 22 using the physical parameters estimated with the high symbol rate signal of 168 GBaud. In each embodiment, the high symbol rate signal is, for example, a signal exceeding 100 GBaud, and the low symbol rate signal is, for example, a signal equal to or less than 100 GBaud.

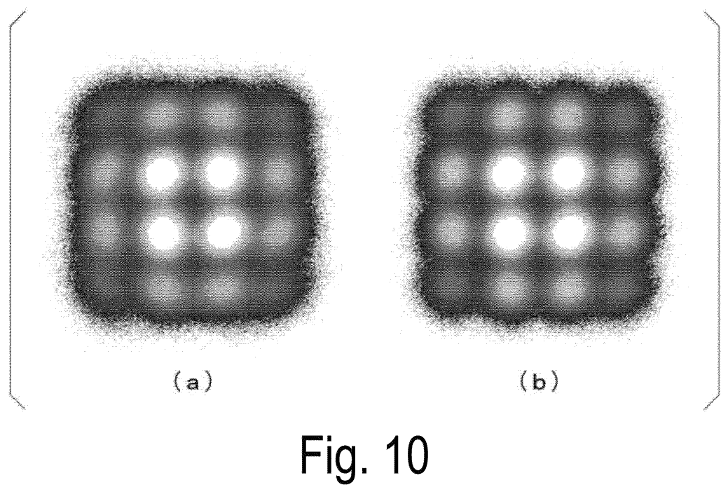

FIG. 10 is a view illustrating a constellation when the injection current of the semiconductor optical amplifier 22 is 350 mA in the high symbol rate signal of 168 GBaud. FIG. 10(a) illustrates a constellation in the case of no distortion compensation of the semiconductor optical amplifier 22, and FIG. 10(b) illustrates a constellation in the case of distortion compensation of the semiconductor optical amplifier 22 using the physical parameters estimated with the 42 GBaud signal. As is clear from FIG. 10, in the constellation in the case of performing compensation using the physical parameters estimated with the 42 GBaud signal, the non-linear distortion is compensated as compared with the constellation in the case of not performing compensation.

According to the optical transceiver 1d of the fourth embodiment configured as described above, it is possible to improve compensation accuracy of the non-linear distortion generated by the semiconductor optical amplifier 22. Specifically, in the optical transceiver 1d, in a case where the optical transmitter 2d operates in the first operation mode, an optical signal based on a low symbol rate signal is transmitted to the optical receiver 4d. The optical receiver 4d estimates non-linear signal distortion of the semiconductor optical amplifier 22 generated when the signal is amplified by the semiconductor optical amplifier 22 on the basis of the optical signal based on the low symbol rate signal. Then, the optical receiver 4d estimates the physical parameters of the semiconductor optical amplifier 22 on the basis of the estimated non-linear signal distortion. Then, in the optical receiver 4d, by accurately calculating a gain coefficient of the non-linear signal distortion when the high symbol rate signal is amplified by the semiconductor optical amplifier 22 using the physical parameters of the semiconductor optical amplifier 22 estimated with the low symbol rate signal, it is possible to improve compensation accuracy of the non-linear distortion generated by the semiconductor optical amplifier 22 of the high symbol rate signal.

### Fifth Embodiment

A fifth embodiment is different from the fourth embodiment in that the optical receiver includes the non-linear signal distortion compensation unit 202 at a subsequent stage of the digital signal processing unit 41. In the fifth embodiment, differences from the fourth embodiment will be mainly described.

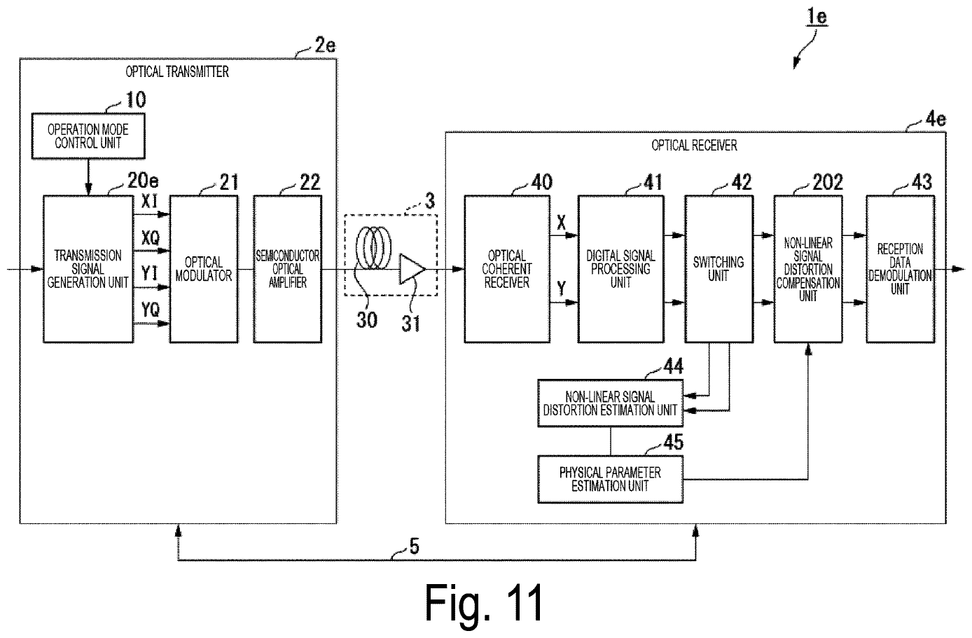

FIG. 11 is a view illustrating a configuration example of an optical transceiver 1e in the fifth embodiment. The optical transceiver 1e includes an optical transmitter 2e, the transmission path 3, an optical receiver 4e, and the control channel 5. The optical transmitter 2e includes the operation mode control unit 10, the transmission signal generation unit 20d, the optical modulator 21, and the semiconductor optical amplifier 22. The optical transmitter 2e includes the semiconductor optical amplifier 22 built in or externally attached thereto. The transmission signal generation unit 20e includes the bit mapping unit 200, the waveform shaping unit 201, and the DAC 203.

The optical receiver 4e includes the optical coherent receiver 40, the digital signal processing unit 41, the switching unit 42, the reception data demodulation unit 43, the non-linear signal distortion estimation unit 44, the physical parameter estimation unit 45, and the non-linear signal distortion compensation unit 202. The optical receiver 4e includes the switching unit 42 and the non-linear signal distortion compensation unit 202 at a subsequent stage of the digital signal processing unit 41. The optical receiver 4e includes the reception data demodulation unit 43 at a subsequent stage of the non-linear signal distortion compensation unit 202. The optical receiver 4e may include the semiconductor optical amplifier 22. The transmission path 3 may include the semiconductor optical amplifier 22.

The switching unit 42 switches a path of an output destination of the reception signal output from the digital signal processing unit 41 according to the operation mode of the optical transmitter 2e. The switching unit 42 is, for example, a switch. In a case where the optical transmitter 2e is operating in the first operation mode, the switching unit 42 switches the path so as to connect the digital signal processing unit 41 and the non-linear signal distortion estimation unit 44. As a result, the switching unit 42 outputs the reception signal output from the digital signal processing unit 41 to the non-linear signal distortion estimation unit 44. As described above, in a case where the optical transmitter 2e is operating in the first operation mode, the switching unit 42 outputs the reception signal to the non-linear signal distortion estimation unit 44 in order to estimate the physical parameters of the semiconductor optical amplifier 22.

In a case where the optical transmitter 2e is operating in the second operation mode, the switching unit 42 switches the path so as to connect the digital signal processing unit 41 and the non-linear signal distortion compensation unit 202. As a result, the switching unit 42 outputs the reception signal output from the digital signal processing unit 41 to the non-linear signal distortion compensation unit 202. The operation mode of the optical transmitter 2e may be notified from the optical transmitter 2e via the control channel 5 or may be notified to the optical receiver 4e using an external device. The switching unit 42 may be incorporated in the digital signal processing unit 41.

The non-linear signal distortion compensation unit 202 acquires the reception signal that is a digital signal from the switching unit 42. The non-linear signal distortion compensation unit 202 acquires the physical parameters of the semiconductor optical amplifier 22 from the physical parameter estimation unit 45.

The non-linear signal distortion compensation unit 202 compensates for non-linear signal distortion generated in the transmission signal by the semiconductor optical amplifier 22 by multiplying the reception signal Eₒ(t) by a value (exp(−h(t)(1+jα)/2)) representing an inverse characteristic of the gain coefficient h(t) of the non-linear signal distortion. As a result, the non-linear signal distortion compensation unit 202 can equalize the non-linear signal distortion generated in the transmission signal by the semiconductor optical amplifier 22.

According to the optical transceiver 1e of the fifth embodiment configured as described above, effects similar to those of the fourth embodiment can be obtained.

At least part of the optical transmitter, the optical receiver, and the optical transceiver in the above-described embodiments may be implemented by a computer. In that case, a program for implementing this function may be recorded in a computer-readable recording medium, and the program recorded in the recording medium may be read and executed by a computer system to implement this function. Note that, the “computer system” referred to herein includes an OS and hardware such as peripheral equipment. In addition, the “computer-readable recording medium” refers to a portable medium such as a flexible disk, a magneto-optical disk, a ROM, or a CD-ROM, or a storage device such as a hard disk built in a computer system. Further, the “computer-readable recording medium” may include a medium that dynamically holds the program for a short period of time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing some of the functions described above, may be implemented in a combination of the functions described above and a program already recorded in a computer system, or may be implemented with a programmable logic device such as a field programmable gate array (FPGA).

Although the embodiments of the present invention have been described above in detail with reference to the drawings, the specific configuration is not limited to the embodiments, and includes design, and the like, within a range not departing from the gist of the present invention.

### INDUSTRIAL APPLICABILITY

The present invention is applicable to a communication device of an optical transmission system.

### REFERENCE SIGNS LIST

1a to 1e Optical transceiver
2a Optical transmitter
3 Transmission path
4a to 4e Optical receiver
5 Control channel
20a to 20e Transmission signal generation unit
21 Optical modulator
22 Semiconductor optical amplifier
30 Optical fiber
31 Optical amplifier
40 Optical coherent receiver
41 Digital signal processing unit
42 Switching unit
43 Reception data demodulation unit
44 Non-linear signal distortion estimation unit
45 Physical parameter estimation unit
200 Bit mapping unit
201 Waveform shaping unit
202 Non-linear signal distortion compensation unit
203 DAC

1. An optical transmission system comprising an optical transmitter and an optical receiver,
the optical transmitter comprising:
an operation mode controller configured to set one of operation modes of a first operation mode for generating a signal of a low symbol rate and a second operation mode for generating a signal of a high symbol rate; and
a transmission signal generator configured to generate a transmission signal according to the operation mode set by the operation mode controller,
the optical receiver comprising:
an optical coherent receiver configured to acquire an optical signal based on the transmission signal and generates a reception signal based on the optical signal;
a digital signal processor configured to perform digital signal processing on the reception signal; and
a reception data demodulator configured to demodulate binary information of a transmission data sequence on a basis of the reception signal subjected to the digital signal processing,
the optical transmitter or the optical receiver comprising:
a non-linear signal distortion compensator configured to calculate a gain coefficient of non-linear signal distortion generated in a transmission signal by a semiconductor optical amplifier on a basis of estimated values of physical parameters of the semiconductor optical amplifier and multiplies the transmission signal by a value representing an inverse characteristic of the gain coefficient;
a non-linear signal distortion estimator configured to acquire the transmission signal and estimates the non-linear signal distortion on a basis of a comparison result between the transmission signal and the reception signal; and
a physical parameter estimator configured to estimate the physical parameters of the semiconductor optical amplifier on a basis of the non-linear signal distortion estimated by the non-linear signal distortion estimator,
wherein the optical receiver switches an output destination such that the reception signal subjected to the digital signal processing is output to the non-linear signal distortion estimator in a case where the optical transmitter is operating in the first operation mode, and switches an output destination such that the reception signal subjected to the digital signal processing is output to the reception data demodulator in a case where the optical transmitter is operating in the second operation mode.

2. The optical transmission system according to claim 1,
wherein in a case where the optical transmitter is operating in the first operation mode,
the non-linear signal distortion compensator does not compensate for non-linear signal distortion generated in the transmission signal by the semiconductor optical amplifier, and
in a case where the optical transmitter is operating in the second operation mode,
the non-linear signal distortion compensator calculates a gain coefficient of the non-linear signal distortion generated in the transmission signal by the semiconductor optical amplifier on a basis of the physical parameters of the semiconductor optical amplifier estimated by the physical parameter estimator.

3. The optical transmission system according to claim 1,
wherein the optical transmitter comprises the non-linear signal distortion compensator, and
the optical receiver comprises:
the non-linear signal distortion estimator; and
the physical parameter estimator.

4. The optical transmission system according to claim 1,
wherein the optical transmitter comprises:
the non-linear signal distortion compensator; and
the physical parameter estimator, and
the optical receiver comprises
the non-linear signal distortion estimator.

5. The optical transmission system according to claim 1,
wherein the optical transmitter comprises:
the non-linear signal distortion compensator;
the non-linear signal distortion estimator; and
the physical parameter estimator.

6. The optical transmission system according to claim 1,
wherein the optical receiver comprises:
the non-linear signal distortion compensator;
the non-linear signal distortion estimator; and
the physical parameter estimator.

7. A signal distortion compensation method to be performed by an optical transmission system comprising an optical transmitter and an optical receiver, the signal distortion compensation method comprising:
the optical transmitter setting one of operation modes of a first operation mode for generating a signal of a low symbol rate and a second operation mode for generating a signal of a high symbol rate,
the optical transmitter generating a transmission signal according to the set operation mode,
the optical receiver acquiring an optical signal based on the transmission signal and generating a reception signal based on the optical signal,
the optical receiver performing digital signal processing on the reception signal,
the optical receiver demodulating binary information of a transmission data sequence on a basis of the reception signal subjected to the digital signal processing,
the optical transmitter or the optical receiver
calculating a gain coefficient of non-linear signal distortion generated in a transmission signal by a semiconductor optical amplifier on a basis of estimated values of physical parameters of the semiconductor optical amplifier,
multiplying the transmission signal by a value representing an inverse characteristic of the gain coefficient,
acquiring the transmission signal and estimating the non-linear signal distortion on a basis of a comparison result between the transmission signal and the reception signal; and
estimating the physical parameters of the semiconductor optical amplifier on a basis of the estimated non-linear signal distortion, and
the optical receiver switching an output destination such that the reception signal subjected to the digital signal processing is output to a non-linear signal distortion estimator that estimates the non-linear signal distortion in a case where the optical transmitter is operating in the first operation mode, and switching an output destination such that the reception signal subjected to the digital signal processing is output to a reception data demodulator that demodulates the binary information of the transmission data sequence in a case where the optical transmitter is operating in the second operation mode.
